(19) United States
(12) Patent Application Publication
(10) Pub. No.: US 2006/0200513 A1
(43) Pub. Date: Sep. 7, 2006

(54) Fast Fourier transform processor and method capable of reducing size of memories

(76) Inventor: Jin-Hee Cheon, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/328,235

(22) Filed: Jan. 10, 2006

(30) Foreign Application Priority Data
Feb. 12, 2005 (KR) 10-2005-0011732

(51) Int. Cl. H04J 11/00; G06F 17/14

(52) U.S. Cl. 708/400; 370/208

(57) ABSTRACT

A fast Fourier transform (FFT) processor performs an FFT operation in each operation stage by carrying out a radix-2 butterfly operation two times every clock cycle on a plurality of N-point data pairs stored in two single port memories, which are classified into two groups according to the respective parity values, and then storing the radix-2 butterfly operation results in the two single port memories. Since the single port memories have a relatively small number of gates, it is possible to reduce memory size required for carrying out the FFT operation.

### CROSS-REFERENCE TO RELATED PATENT APPLICATION

This application claims the benefit of Korean Patent Application No. 10-2005-0011732, filed on Feb. 12, 2005, in the Korean Intellectual Property Office, the disclosure of which is incorporated herein in its entirety by reference for all purposes as if fully set forth herein.

### BACKGROUND OF THE INVENTION

1. Field of the Invention

The present invention relates to a wired or wireless communication system, and more particularly, to a fast Fourier transform (FFT) processor and method, which can be employed by a transceiver for wired or wireless communications to carry out a modulation or demodulation operation.

2. Description of the Related Art

A transceiver in a system, such as a wireless LAN system, an asymmetric digital subscriber line (ADSL) system, a very high-data rate digital subscriber line (VDSL) system, a orthogonal frequency division multiplexing (OFDM) system, a digital audio broadcasting (DAB) system, or a multi-carrier modulation (MCM) system, includes a processor that carries out a fast Fourier transform (FFT) operation.

An FFT algorithm is a method of reducing the amount of computations for a discrete Fourier transformation, shown in Equation (1) below, by eliminating repeated computation processes:

$$X ( k ) = {\sum }_{n = 0}^{N - 1} x ( n ) {ⅇ}^{- j \frac{2 π}{N} {n}_{k}} , 0 \leq k \leq N - 1 \qquad ( 1 )$$

where n is a time index, k is a frequency index, N the number of data points, and

$${ⅇ}^{- j \frac{2 π}{N} {n}_{k}} = {W}_{N}^{nk}$$

(twiddle factor). An example of an FFT apparatus to which the FFT algorithm is applied is disclosed in U.S. Pat. No. 6,356,926, the contents of which are incorporated herein by reference.

An FFT operation performed in a receiver converts time-domain signals into frequency-domain signals. On the other hand, an inverse FFT operation performed in a transmitter converts frequency-domain signals into time-domain signals.

FIG. 1 is a signal flow diagram illustrating a typical 16-point radix-2 decimation-in-frequency (DIF) FFT algorithm, i.e., an FFT operation having a number of data points, N=16. Referring to FIG. 1, input data x(0) through x(15) are sequentially subjected to four operation stages (4=log₂ 16), and thus output data X(0) through X(15) are output. For example, each of the input data x(0) through x(15) may have a width of 20 bits. In each of the operation stages, a radix-2 butterfly operation is carried out. Eight twiddle factors W₁₆⁰ through W₁₆⁷ are needed in the first operation stage, four twiddle factors W₁₆⁰, W₁₆², W₁₆⁴, and W₁₆⁶ are needed in the second operation stage, and 2 twiddle factors W₁₆⁰ and W₁₆⁴ are needed in the third operation stage. The output data X(0) through X(15) are output in a reverse digit order and are aligned in a natural order and then input to an equalizer.

FIG. 2 is a diagram illustrating the arrangement of four dual port memories that realizes the FFT algorithm of FIG. 1. Referring to FIG. 2, a first group of input data x(0) through x(7) are stored in or written to first through eighth addresses, respectively, of a first upper dual port memory (UPD1). Thereafter, output data (i.e., a set of radix-2 operations) of the second and fourth operation stages (i.e., the even-numbered operation stages) corresponding to the first group of input data x(0) through x(7) are restored in, or overwritten to, the first through eighth addresses, respectively, of the first upper dual port memory UPD1.

A second group of input data x(8) through x(15) are stored in first through eighth addresses, respectively, of a first lower dual port memory DND1. Thereafter, output data of the second and fourth operation stages corresponding to the second group of input data x(8) through x(15) are restored in the first through eighth addresses, respectively, of the first lower dual port memory DND1.

Output data of the first and third operation stages (i.e., odd-numbered operation stages) corresponding to the first group of input data x(0) through x(7) are restored in first through eighth addresses, respectively, of a second upper dual port memory UPD2.

Output data of the first and third operation stages corresponding to the second group of input data x(8) through x(15) are restored in the first through eighth addresses, respectively, of a second lower dual port memory DND2.

FIG. 3 is a block diagram illustrating a conventional FFT processor 100 having the four dual port memories UPD1, DND1, UPD2, and DND2 of FIG. 2. Referring to FIG. 3, FFT processor 100 includes the first upper dual port memory UPD1, the first lower dual port memory DND1, the second upper dual port memory UPD2, the second lower dual port memory DND2, a first butterfly operator 110, a second butterfly operator 120, a first switch circuit (SW1) 130, and a second switch circuit (SW2) 140.

FFT processor 100 performs a radix-2 butterfly operation two times every clock cycle using first and second butterfly operators 110 and 120. Accordingly, supposing that there are 16 input data and two radix-2 butterfly operations carried out on the 16 input data constitute one operation stage, four clock cycles are required for carrying out one operation stage, and a total of 16 clock cycles are required for carrying out four operation stages.

Two input data among a first group of input data x(0) through x(7) or two output data among eight output data of the second and fourth operation stages corresponding to the first group of input data x(0) through x(7) are simultaneously input to/output from (or written to/read from) first and second ports PU11 and PU21 of the first upper dual port memory UPD1.

Two input data among a second group of input data x(8) through x(15) or two output data among eight output data of the second and fourth operation stages corresponding to the second group of input data x(8) through x(15) are simultaneously input to/output from (or written to/read from) first and second ports PD11 and PD21 of the first lower dual port memory UPD1.

Two output data among eight output data of the first and third operation stages corresponding to the first group of input data x(0) through x(7) are simultaneously input to or output from first and second ports PU12 and PU22 of the second upper dual port memory UPD2.

Two output data among eight output data of the first and third operation stages corresponding to the second group of input data x(8) through x(15) are simultaneously input to or output from first and second ports PD12 and PD22 of the second lower dual port memory DND2.

Data are input to or output from first butterfly operator 110 via first through fourth ports T11, T21, T31, and T41. Specifically, the first and second ports T11 and T21 are used as input ports in the first and third operation stages and are used as output ports in the second and fourth operation stages, and the third and fourth ports T31 and T41 are used as input ports in the second and fourth operation stages and are used as output ports in the first and third operation stages. For example, in the first operation stage, the first input data x(0) and the second input data x(8), which are subjected to a butterfly operation carried out by first butterfly operator 110, are input to first butterfly operator 110 via the first and second ports T11 and T21. In the first through third operation stages, the twiddle factor W₁₆^{K} (where K is an integer between 0 and 7) required for an FFT operation is input to first butterfly operator 110.

Data are input to or output from the second butterfly operator 120 via first through fourth ports T12, T22, T32, and T42. Specifically, the first and second ports T12 and T22 are used as input ports in the first and third operation stages and are used as output ports in the second and fourth operation stages, and the third and fourth input ports T32 and T42 are used as input ports in the second and fourth operation stages and are used as output ports in the first and third operation stages. For example, in the first operation stage, the second input data x(1) and the tenth input data x(9), which are subjected to a butterfly operation carried out by second butterfly operator 120, are input to second butterfly operator 120 via the first and second ports T12 and T22. In the first through third operation stages, the twiddle factor W₁₆^{K} (where K is an integer between 0 and 7) required for an FFT operation is input to the second butterfly operator 120.

First and second switch circuits 130 and 140 control the four dual port memories UPD1, DND1, UPD2, and DND2 and first and second butterfly operators 110 and 120 to achieve a signal flow (or a data flow) of the typical FFT algorithm illustrated in FIG. 1.

The operation of first switch circuit 130 in the first operation stage will now be described in detail. The second input data x(1) output via the second port PU21 of the first upper dual port memory UPD1 is transmitted to the first port T12 of second butterfly operator 120 by first switch circuit 130. The ninth input data x(8) output from the first port PD11 of the first lower dual port memory DND1 is transmitted to the second port T21 of first butterfly operator 110 by first switch circuit 130. The operation of second switch circuit 140 in the first operation stage is similar to the operation of first switch circuit 130 in the first operation stage, and thus its detailed description will be skipped.

FIG. 4 is a diagram illustrating first or second butterfly operator 110 or 120 of FIG. 3. Referring to FIG. 4, first or second butterfly operator 110 or 120 includes a complex adder 111, a complex subtractor 112, and a complex multiplier 113.

Complex adder 111 adds first input data IN1 and second input data IN2 input thereto via input ports and outputs the addition result, i.e., first output data OUT1, via the output port. Complex subtractor 112 subtracts the second input data IN2 from the first input data IN1 and outputs the subtraction result to complex multiplier 113. Complex multiplier 113 multiplies the subtraction result output from complex subtractor 112 by the twiddle factor W₁₆^{K} (where K is an integer between 0 and 7) and outputs the multiplication result, i.e., second output data OUT2, via the output port.

A dual port memory (e.g., a dual port RAM), such as the first upper dual port memory UPD1, the first lower dual port memory DND1, the second upper dual port memory UPD2, or the second lower dual port memory DND2 of FIG. 3, includes almost twice the number of gates included in a single port memory having the same bit capacity (=bit width×bit depth) as the dual port memory. The number of gates is directly proportional to the number of ports of a memory. Accordingly, the conventional FFT processor can increase its memory size required for carrying out an FFT operation using dual port memories. Accordingly, it would be desirable to provide a fast Fourier transform (FFT) processor which can reduce the memory size required for carrying out an FFT operation using a single port memory with fewer gates.

### SUMMARY OF THE INVENTION

According to one aspect of the present invention, a fast Fourier transform (FFT) processor performs an FFT algorithm. The FFT processor includes a first upper single port memory, which stores at first addresses upper input data pairs where an index value of each upper input data pair has a first parity value, and restores output data pairs of an even-numbered operation stage corresponding to the upper input data pairs at the first addresses. The FFT processor also includes a first lower single port memory, which stores at second addresses lower input data pairs where an index value of each lower input data pair has a second parity value, and restores output data pairs of the even-numbered operation stage corresponding to the lower input data pairs at the second addresses. The FFT processor further includes: a second upper single port memory, which restores output data pairs of an odd-numbered operation stage corresponding to the upper input data pairs at third addresses; a second lower single port memory, which stores output data pairs of the odd-numbered operation stage corresponding to the lower input data pairs at fourth addresses; and first and second butterfly operators, each of which generates one of the output data pairs by performing a radix-2 butterfly operation on a first input data pair corresponding to one of the upper input data pairs and a second input data pair corresponding to one of the lower input data pairs in the odd-numbered and even-numbered operation stages.

The FFT processor may also include: first and second switch circuits, which control the first upper and lower single port memories, the second upper and lower single port memories, and the first and second butterfly operators to achieve a data flow of the FFT algorithm.

The first and second parity values may each be an odd parity value which is calculated, respectively, using all of a plurality of bits of the index value of input data in each of the upper input data pairs excluding a least significant bit and using all of a plurality of bits of the index value of input data in each of the lower input data pairs excluding a least significant bit

The numbers of first addresses, second addresses, third addresses, and fourth addresses may be equal, and addresses included in each of the first, second, third and fourth addresses may be numbered in like manner.

If the number of the upper input data pair is four and the number of the lower input data pair is four, the last even-numbered operation stage may be a fourth operation stage.

The FFT algorithm may be realized as a decimation-in-frequency (DIF) algorithm.

The first and second switch circuits may be controlled by an FFT controller that controls the FFT processor entirely.

In another aspect of the invention, a method of performing a fast Fourier transform on asset of input data, comprises: separating the input data into upper input data and lower input data, wherein an index value of each of the upper input data pairs has a first parity value and an index value of each of the lower input data pairs has a second parity value; storing at first addresses in a first upper single port memory the upper input data pairs, and restoring at the first addresses in the first upper single port memory output data pairs of an even-numbered operation stage of the FFT algorithm corresponding to the upper input data pairs; storing at second addresses in a first lower single port memory the lower input data pairs, and restoring at the second addresses in the first lower single port memory output data pairs of the even-numbered operation stage corresponding to the lower input data pairs; storing at third addresses in a second upper single port memory output data pairs of an odd-numbered operation stage of the FFT algorithm corresponding to the upper input data pairs; storing at fourth addresses in a second lower single port memory output data pairs of the odd-numbered operation stage of the FFT algorithm corresponding to the lower input data pairs; and generating output data pairs by performing a radix-2 butterfly operation on a first input data pair corresponding to one of the upper input data pairs and a second input data pair corresponding to one of the lower input data pairs in the odd-numbered and even-numbered operation stages

### BRIEF DESCRIPTION OF THE DRAWINGS

The above and other features and advantages of the present invention will become more apparent by describing in detail exemplary embodiments thereof with reference to the attached drawings in which:

FIG. 1 is a signal flow diagram illustrating a typical 16-point radix-2 decimation-in-frequency (DIF) fast Fourier transform (FFT) algorithm;

FIG. 2 is a diagram illustrating the arrangement of four dual port memories used for realizing the FFT algorithm of FIG. 1;

FIG. 3 is a block diagram illustrating a conventional FFT processor including the four dual port memories of FIG. 2;

FIG. 4 is a diagram illustrating a first or second butterfly operator of FIG. 3;

FIG. 5 is a diagram illustrating the arrangement of four single port memories used for realizing the FFT algorithm of FIG. 1 according to an exemplary embodiment;

FIG. 6 is a table indicating in which addresses in first upper and lower single port memories of FIG. 5 a plurality of pairs of input data are respectively stored;

FIG. 7 is a block diagram illustrating an FFT processor having the four single port memories of FIG. 5 according to an exemplary embodiment; and

FIG. 8 is a diagram illustrating a first and second butterfly operators of FIG. 7.

### DETAILED DESCRIPTION

The present invention will now be described more fully with reference to the accompanying drawings in which exemplary embodiments of the invention are shown. In the drawings, like reference numerals represent like elements.

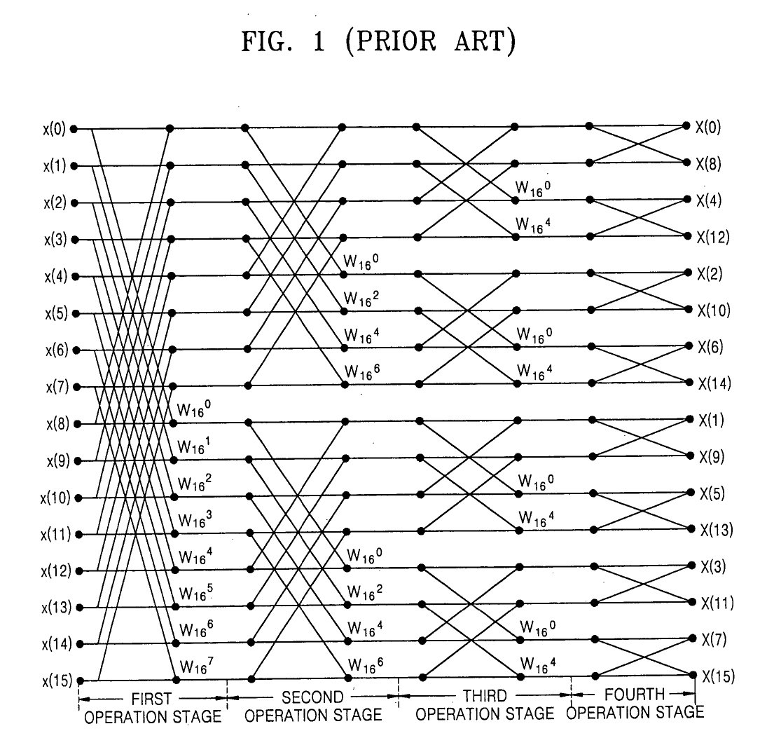

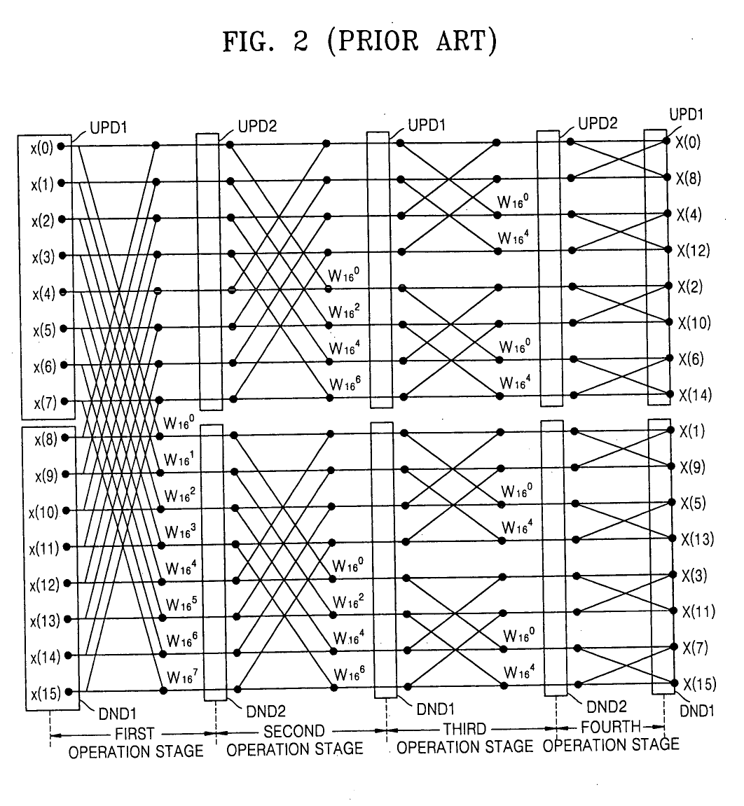

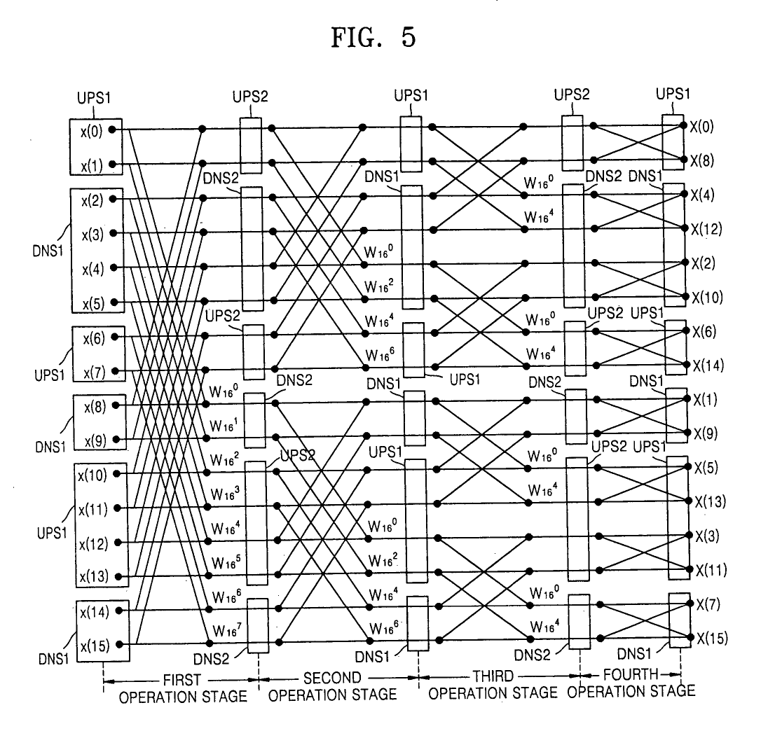

FIG. 5 is a diagram illustrating the arrangement of four single port memories used for realizing the FFT algorithm of FIG. 1. Referring to FIG. 5, four pairs of data {x(0), x(1)}, {x(6), x(7)}, {x(10), x(11)}, and {x(12), x(13)} (hereinafter referred to as upper input data pairs) having a first parity value, which is obtained from index values of sixteen input data x(0) through x(15), are input to a first upper single port memory UPS1 and then sequentially stored at first addresses in the first upper single port memory UPS1. Thereafter, pairs of output data of second and fourth operation stages (i.e., an even-numbered operation stages) corresponding to the upper input data pairs {x(0), x(1)}, {x(6), x(7)}, {x(10), x(11)}, and {x(12), x(13)} are sequentially restored at the first addresses in the first upper single port memory UPS1 where the respective upper input data pairs are restored.

Four pairs of data {x(2), x(3)}, {x(4), x(5)}, {x(8), x(9)}, and {x(14), x(15)} (hereinafter referred to as lower input data pairs) having a second parity value, which is obtained from the index values of the sixteen input data x(0) through x(15), are input to a first lower single port memory DNS1 and then sequentially stored at second addresses in the first lower single port memory DNS1. Thereafter, pairs of output data of the second and fourth operation stages corresponding to the lower input data pairs {x(2), x(3)}, {x(4), x(5)}, {x(8), x(9)}, and {x(14), x(15)} are sequentially restored at the second addresses in the first lower single port memory DNS1 where the respective lower input data pairs are stored.

Pairs of output data of first and third operation stages (i.e., odd-numbered operation stages) corresponding to the upper input data pairs {x(0), x(1)}, {x(6), x(7)}, {x(10), x(11)}, and {x(12), x(13)} are sequentially stored at third addresses in a second upper single port memory UPS2.

Pairs of output data of the first and third operation stages corresponding to the lower input data pairs {x(2), x(3)}, {x(4), x(5)}, {x(8), x(9)}, and {x(14), x(15)} are sequentially stored at fourth addresses in a second lower single port memory DNS2.

Preferably, the numbers of first addresses, second addresses, third addresses, and fourth addresses are equal, and addresses included in each of the first, second, third, and fourth addresses are numbered in like manner.

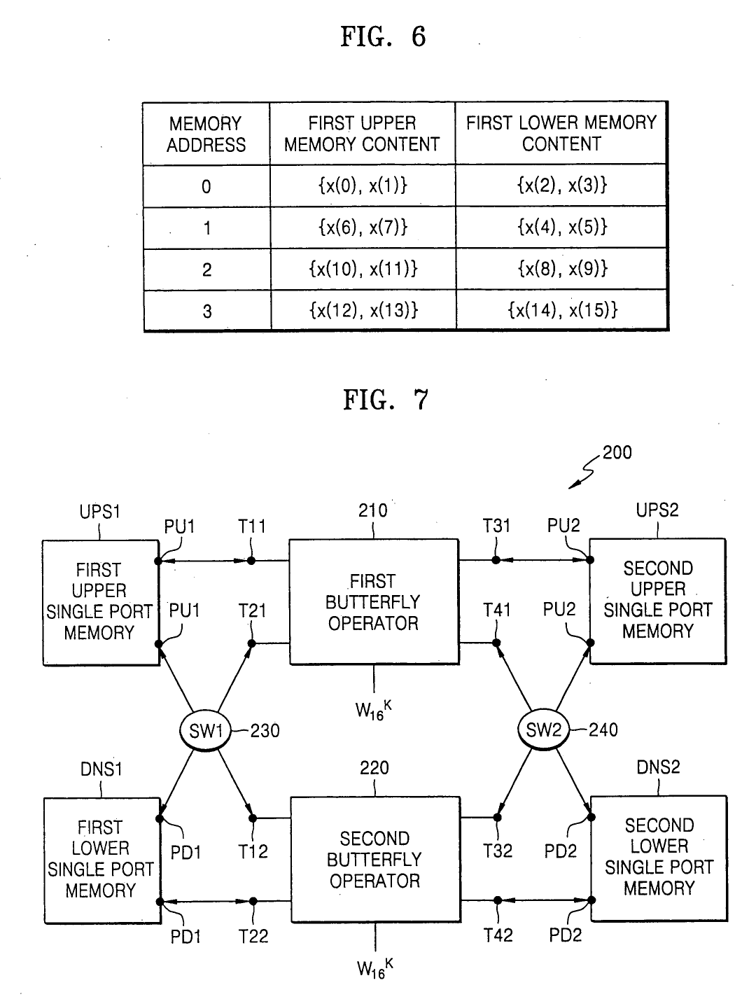

FIG. 6 is a table indicating in which addresses in the first upper and lower single port memories UPS1 and DNS1 of FIG. 5 upper input data pairs and lower input data pairs are respectively stored. Referring to FIG. 6, upper input data pairs {x(0), x(1)}, {x(6), x(7)}, {x(10), x(11)}, and {x(12), x(13)} are stored at first addresses 0, 1, 2, and 3, respectively, in the first upper single port memory UPS1, and lower input data pairs {x(2), x(3)}, {x(4), x(5)}, {x(8), x(9)}, and {x(14), x(15)} are stored at second addresses 0, 1, 2, and 3, respectively, in the first lower single port memory DNS1.

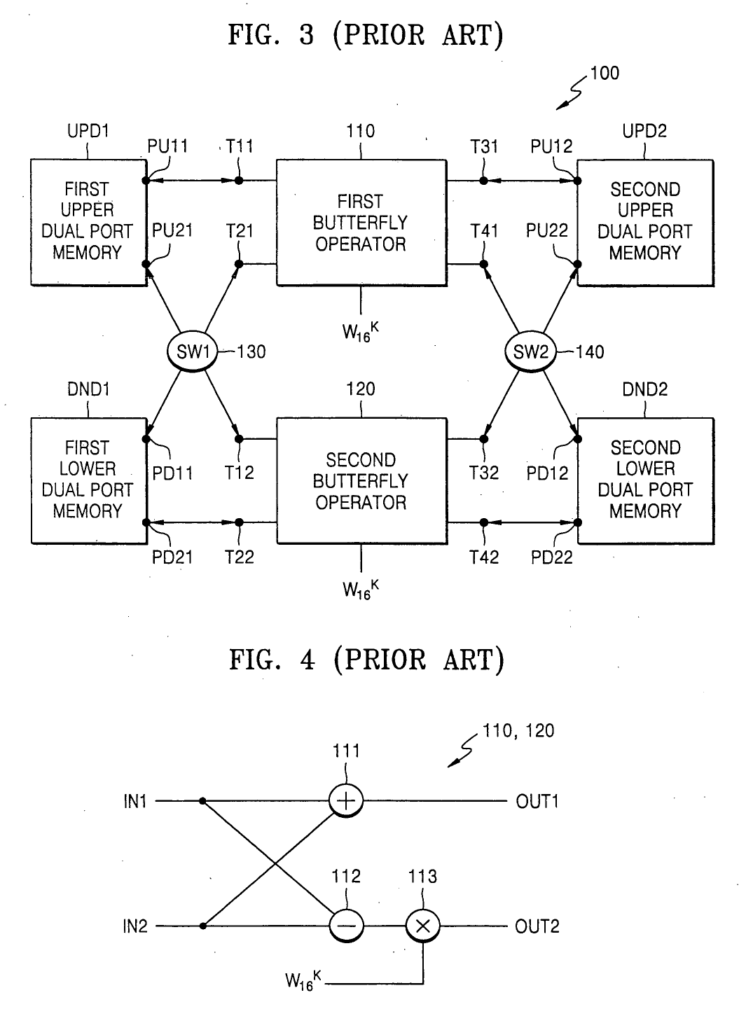

A single port memory of an FFT processor according to the exemplary embodiment of FIG. 5 has the same bit capacity as the dual port memory of conventional FFT processor 100 of FIG. 3 but can store data having twice the bit width and half of the bit depth of data that can be stored in the dual port memory of conventional FFT processor 100. Accordingly, the single port memory of the FFT processor according to the exemplary embodiment of FIG. 5 has half of the number of addresses of the conventional FFT processor 100.

It is determined whether to store a predetermined pair of input data in the first upper single port memory UPS1 or in the first lower single port memory DNS1 based on an odd parity value calculated using a plurality of bits of an index value of the pair of input data excluding a least significant bit (LSB). For example, since a pair of input data x(0) and x(1) have an index value of “0000 (=0)” and an index value of “0001 (=1)”, respectively, bits of the index values of the pair of input data x(0) and x(1) excluding LSBs are “000”, and an odd parity value for “000” is a first parity value of 0. Thus, the pair of input data x(0) and x(1) are stored in the first upper single port memory UPS1. On the other hand, since a pair of input data x(2) and x(3) have an index value of “0010 (=2)” and an index value of “0011 (=3)”, respectively, bits of each of the index values of the pair of input data x(2) and x(3) excluding LSBs are “001”, and an odd parity value is a second parity value of 1. Thus, the pair of input data x(2) and x(3) are stored in the first lower single port memory DNS1. In this manner, it is determined whether to store other pairs of input data in the first upper single port memory UPS1 or in the first lower single port memory DNS1. Alternatively, pairs of input data having the first parity value may be stored in the first lower single port memory DNS1, and pairs of input data having the second parity value may be stored in the second upper single port memory UPS1.

FIG. 7 is a block diagram illustrating an FFT processor 200 having the four upper single port memories UPS1, DNS1, UPS2, and DNS2 of FIG. 5 according to an exemplary embodiment. Referring to FIG. 7, the FFT processor 200 includes the first upper single port memory UPS1, the first lower single port memory DNS1, the second upper single port memory UPS2, the second lower single port memory DNS2, a first butterfly operator 210, a second butterfly operator 220, a first switch circuit (SW1) 230, and a second switch circuit (SW2) 240.

The FFT processor 200 performs a radix-2 butterfly operation two times every clock cycle using the first and second butterfly operators 210 and 220. Accordingly, supposing that there are sixteen input data and two radix-2 butterfly operations carried out on the sixteen input data constitute one operation stage, four clock cycles are required for carrying out one operation stage, and a total of sixteen clock cycles are required for carrying out four operation stages.

One of four upper input data pairs {x(0), x(1)}, {x(6), x(7)}, {x(10), x(11)}, and {x(12), x(13)} or one of four output data pairs of the second and fourth operation stages corresponding to the four upper input data pairs {x(0), x(1)}, {x(6), x(7)}, {x(10), x(11)}, and {x(12), x(13)} is simultaneously input to or output from a port PU1 of the first upper single port memory UPS1.

One of four lower input data pairs {x(2), x(3)}, {x(4), x(5)}, {x(8), x(9)}, and {x(14), x(15)} or one of four output data pairs of the second and fourth operation stages corresponding to the four upper input data pairs {x(2), x(3)}, {x(4), x(5)}, {x(8), x(9)}, and {x(14), x(15)} is simultaneously input to or output from a port PD1 of the first lower single port memory DNS1.

One of four output data pairs of the first and third operation stages corresponding to the upper input data pairs {x(0), x(1)}, {x(6), x(7)}, {x(10), x(11)}, and {x(12), x(13)} is simultaneously input to or output from a port PU2 of the second upper single port memory UPS2.

One of four output data pairs of the first and third operation stages corresponding to the lower input data pairs {x(2), x(3)}, {x(4), x(5)}, {x(8), x(9)}, and {x(14), x(15)} is simultaneously input to or output from a port PD2 of the second lower single port memory DNS2.

Data is input to or output from first butterfly operator 210 via first through fourth ports T11, T21, T31, and T41. Specifically, the first and second ports T11 and T21 are used as input ports in the first and third operation stages and are used as output ports in the second and fourth operation stages, and the third and fourth ports T31 and T41 are used as input ports in the second and fourth operation stages and are used as output ports in the first and third operation stages. For example, in the first operation stage, x(0) of a first input data pair in the upper input data pairs and x(8) of a third input data pair in the lower input data pairs, which are subjected to a butterfly operation carried out by first butterfly operator 210, are input to first butterfly operator 210 via the first and second ports T11 and T21. In addition, in the first operation stage, x(11) of a third input data pair in the upper input data pairs and x(3) of a first input data pair in the lower input data pairs, which are subjected to a butterfly operation carried out by first butterfly operator 210, are input to first butterfly operator 210 via the first and second ports T11 and T21. In the first through third operation stages, the twiddle factor W₁₆^{K} (where K is an integer between 0 and 7) required for an FFT operation is input to first butterfly operator 210.

Data is input to or output from second butterfly operator 220 via first through fourth ports T12, T22, T32, and T42. Specifically, the first and second ports T12 and T22 are used as input ports in the first and third operation stages and are used as output ports in the second and fourth operation stages, and the third and fourth input ports T32 and T42 are used as input ports in the second and fourth operation stages and are used as output ports in the first and third operation stages. For example, in the first operation stage, the input data x(1) and x(9), which are subjected to a butterfly operation carried out by second butterfly operator 220, are input to second butterfly operator 220 via the first and second ports T12 and T22. In addition, in the first operation stage, the input data x(10) and x(2), which are subjected to a butterfly operation carried out by second butterfly operator 220, are input to second butterfly operator 220 via the first and second ports T12 and T22. In the first through third operation stages, the twiddle factor W₁₆^{K} (where K is an integer between 0 and 7) required for an FFT operation is input to second butterfly operator 220.

First and second switch circuits 230 and 240 control the four dual port memories UPS1, DNS1, UPS2, and DNS2 and first and second butterfly operators 210 and 220 to achieve a signal flow (or a data flow) of the FFT algorithm illustrated in FIG. 5. First and second switch circuits 230 and 240 are controlled by an FFT controller (not shown) that controls the entire FFT processor 200 of FIG. 7.

The operation of first switch circuit 230 in the first operation stage will now be described in detail. First switch circuit 230 transmits the input data x(1) output from the port PU1 of the first upper single port memory UPS1 to the first port T12 of second butterfly operator 220 and transmits the input data x(8) output from the port PD1 of the first lower single port memory DNS1 to the second port T21 of first butterfly operator 210. In addition, first switch circuit 230 transmits the input data x(10) output from the port PU1 of the first upper single port memory UPS1 to the first port T12 of second butterfly operator 220 and transmits the input data x(3) output from the port PD1 of the first lower single port memory DNS1 to the second port T21 of first butterfly operator 210.

The operation of second switch circuit 240 in the first operation stage is similar to the operation of first switch circuit 230 in the first operation stage. The operation of first and second switch circuits 230 and 240 in the second and third operation stages is similar to the operations of first and second switch circuits 230 and 240 in the first operation stage. In the fourth operation stage, however, second switch circuit 240 transmits output data of the third operation stage stored in the second upper single port memory UPS2 to the fourth port T41 of first butterfly operator 210 via the port PU2 and transmits output data of the third operation stage and stored in the second lower single port memory DNS2 to the third port T32 of second butterfly operator 220 via the port PD2. The operation of first switch circuit 230 in the fourth operation stage is similar to the operation of second switch circuit 240 in the fourth operation stage.

As described above, FFT processor 200 of FIG. 7 performs an FFT operation using single port memories having a relatively small number of gates and thus can reduce memory size required for carrying out the FFT operation. Even though FFT processor 200 has been described above as carrying out an FFT algorithm embodied as a DIF algorithm, it may perform an FFT operation embodied as a decimation-in-time (DIT) algorithm. In addition, FFT processor 200 can perform an 8-point or 32-point FFT operation as well as, or instead of, a 16-point FFT operation.

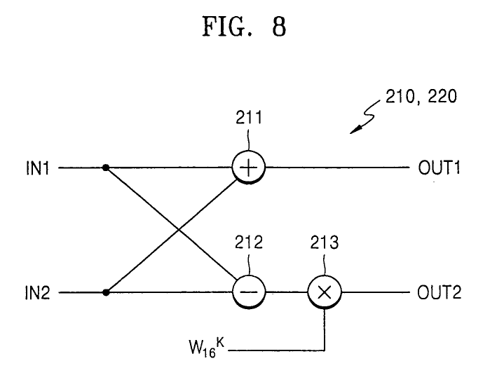

FIG. 8 is a diagram illustrating a configuration of first and second butterfly operators 210 and 220 of FIG. 7. Referring to FIG. 8, first and second butterfly operators 210 and 220 each include a complex adder 211, a complex subtractor 212, and a complex multiplier 213.

Complex adder 211 adds first input data IN1 and second input data IN2 input thereto via input ports and outputs the addition result, i.e., first output data OUT1, via the output port. Complex subtractor 212 subtracts the second input data IN2 from the first input data IN1 and outputs the subtraction result to complex multiplier 213. Complex multiplier 213 multiplies the subtraction result output from Complex subtractor 212 by the twiddle factor W₁₆^{K} (where K is an integer between 0 and 7) and outputs the multiplication result, i.e., second output data OUT2, via the output port.

While the present invention has been particularly shown and described with reference to exemplary embodiments thereof, it will be understood by those of ordinary skill in the art that various changes in form and details may be made therein without departing from the scope of the present invention as defined by the following claims.

What is claimed is:

1. A fast Fourier transform (FFT) processor that performs an FFT algorithm, the FFT processor comprising:
a first upper single port memory, which stores at first addresses upper input data pairs where an index value of each upper input data pair has a first parity value, and which restores at the first addresses output data pairs of an even-numbered operation stage of the FFT algorithm corresponding to the upper input data pairs;
a first lower single port memory, which stores at second addresses lower input data pairs where an index value of each lower input data pair has a second parity value, and which restores at the second addresses output data pairs of the even-numbered operation stage corresponding to the lower input data pairs;
a second upper single port memory, which stores output data pairs of an odd-numbered operation stage corresponding to the upper input data pairs at third addresses;
a second lower single port memory, which stores output data pairs of the odd-numbered operation stage corresponding to the lower input data pairs at fourth addresses; and
first and second butterfly operators, each of which generates one of the output data pairs by performing a radix-2 butterfly operation on a first input data pair corresponding to one of the upper input data pairs and a second input data pair corresponding to one of the lower input data pairs in the odd-numbered and even-numbered operation stages.

2. The FFT processor of claim 1 further comprising:
first and second switch circuits, which control the first upper and lower single port memories, the second upper and lower single port memories, and the first and second butterfly operators to achieve a data flow of the FFT algorithm.

3. The FFT processor of claim 1, wherein the first and second parity values are each an odd parity value which is calculated, respectively, using all of a plurality of bits of the index value of input data in each of the upper input data pairs excluding a least significant bit and using all of a plurality of bits of the index value of input data in each of the lower input data pairs excluding a least significant bit.

4. The FFT processor of claim 1, wherein the numbers of first addresses, second addresses, third addresses, and fourth addresses are equal, and addresses included in each of the first, second, third and fourth addresses are numbered in like manner.

5. The FFT processor of claim 1, wherein if the number of the upper input data pairs is four and the number of the lower input data pairs is four, a last even-numbered operation stage is a fourth operation stage.

6. The FFT processor of claim 1, wherein the FFT algorithm is realized as a decimation-in-frequency (DIF) algorithm.

7. The FFT processor of claim 2, wherein the first and second switch circuits are controlled by an FFT controller that controls the FFT processor entirely.

8. A method of performing a fast Fourier transform on asset of input data, comprising:
separating the input data into upper input data and lower input data, wherein an index value of each of the upper input data pairs has a first parity value and an index value of each of the lower input data pairs has a second parity value;
storing at first addresses in a first upper single port memory the upper input data pairs, and restoring at the first addresses in the first upper single port memory output data pairs of an even-numbered operation stage of the FFT algorithm corresponding to the upper input data pairs;
storing at second addresses in a first lower single port memory the lower input data pairs, and restoring at the second addresses in the first lower single port memory output data pairs of the even-numbered operation stage corresponding to the lower input data pairs;
storing at third addresses in a second upper single port memory output data pairs of an odd-numbered operation stage of the FFT algorithm corresponding to the upper input data pairs;
storing at fourth addresses in a second lower single port memory output data pairs of the odd-numbered operation stage of the FFT algorithm corresponding to the lower input data pairs; and
generating output data pairs by performing a radix-2 butterfly operation on a first input data pair corresponding to one of the upper input data pairs and a second input data pair corresponding to one of the lower input data pairs in the odd-numbered and even-numbered operation stages.

9. The method of claim 8, wherein the first and second parity values are each an odd parity value which is calculated, respectively, using all of a plurality of bits of the index value of input data in each of the upper input data pairs excluding a least significant bit and using all of a plurality of bits of the index value of input data in each of the lower input data pairs excluding a least significant bit.

10. The method of clam 8, wherein the numbers of first addresses, second addresses, third addresses, and fourth addresses are equal, and addresses included in each of the first, second, third and fourth addresses are numbered in like manner.

11. The method of clam 8, wherein the FFT algorithm is realized as a decimation-in-frequency (DIF) algorithm.
